(19) United States
(12) Patent Application Publication
(10) Pub. No.: US 2022/0290414 A1
(43) Pub. Date: Sep. 15, 2022

(54) WATER RESOURCES UTILIZATION STRUCTURE

(71) Applicant: Ha-Jeong CHOI, Daejeon, Seo-Gu (KR)

(72) Inventor: Ha-Jeong CHOI, Daejeon, Seo-Gu (KR)

(21) Appl. No.: 17/639,621

(22) PCT Filed: Nov. 4, 2019
(86) PCT No.: PCT/KR2019/014808

§ 371 Date: Mar. 2, 2022

(30) Foreign Application Priority Data
Sep. 2, 2019 (KR) 10-2019-0108036

(51) Int. Cl. E03B 3/02; E03F 5/10; A01G 25/06

(52) U.S. Cl. CPC E03B 3/02; E03F 5/106; A01G 25/06; A01G 2025/003

(57) ABSTRACT

The present invention relates to a water resource utilization structure that collects and stores water resources penetrating the ground, such as rainwater or melted snow, and distributes and utilizes the stored water resources for various purposes such as housing, vegetation, trees, industry, and fire.
1. It is a structure that utilizes water resources to respond to global environmental disasters and climate change with a focus on water circulation, water storage, and water supply.
2. In other words, it is a water resource utilization structure for sustainable green growth in response to global climate change.

### TECHNICAL FIELD

The present invention relates to a water resource utilization structure, and more particularly, to a water resource utilization structure capable of collecting and storing water resources permeated into the ground such as rainwater or snow and distributing the stored water resources for various purposes such as residential, vegetation, tree, industrial, fire suppression, and the like.

### BACKGROUND ART

In general, water resources such as rainwater or snow are stored in a reservoir or a dam form through a waterway, and then distributed as necessary for home or agricultural purposes.

In particular, rainwater or snow melting water is collected and transported by a perforated pipe to be managed in a form of being transported and discharged. In other words, the pipe-shaped perforated pipe does not collect water resources permeated into the ground, and is not able to efficiently utilize the water resources because water resources are not stored.

### PRIOR ART

### Patent Document

### NON-ESTABLISHMENT OF OPINION WITH REGARD TO NOVELTY, INVENTIVE STEP AND INDUSTRIAL APPLICABILITY

### PATENT COOPERATION TREATY. FROM THE. INTERNATIONAL SEARCHING AUTHORITY

### PATENT COOPERATION TREATY. FROM THE. INTERNATIONAL SEARCHING AUTHORITY

### DETAILED DESCRIPTION OF THE INVENTION

### Technical Problem

The purpose of the present invention is to provide a water resource utilization structure which collects and stores and stores water resources such as rainwater or snow, which is permeated into the ground, and distributes and stores water resources such as water, industrial use, and the like, and can efficiently utilize the water resources.

### Problem Solving Means

To this end, the water resource utilization structure according to the present invention is a water resource utilization structure for collecting and storing water resources permeated into the ground and distributing the water resources to a place requiring the stored water resources The water resource utilization structure comprises: a water resource collection part having an open upper part and storing and transferring water resources through an inner water storage space; a water resource collection part coupled to the opened upper part of the water resource waterway part,; a water storage tank which collects and stores water resources transferred by being transferred through the water resource waterway part; and a water resource storage part which is coupled to the opened upper part of the water storage tank to enter a water resource flowing from the upper part into a water storage tank located in the lower part, and has a water storage tank evaporation blocking part for preventing evaporation of the water resources stored in the water storage tank.

a water resource block unit for blocking and storing the flow of water resources collected in the water resource waterway unit; and a water resource flow unit having a groove in which a water resource can be transferred is formed on an upper portion of the water resource block unit, and when the water level of the water resource stored in the water resource waterway unit is greater than or equal to the water resource flow unit of the water resource block unit, the water resource is transferred to one side to be introduced into the water storage tank.

In addition, a tree drain pipe for supplying the stored water resources to a tree is formed in the water resource waterway part, and a drip part is provided at one end of the tree drain pipe to distribute and supply water resources to the root part of the tree, wherein a cap having a partial fine net is attached to the drip part to suppress clogging due to soil.

and a bimetal opening and closing unit for opening and closing the drain pipe for fire suppression through heat transferred through the bimetal unit when the heat of the set temperature or more is sensed by the temperature sensing unit; a Bernoulli screw unit for applying rotational force to the transfer of the water resource through the twisted S-shaped screw when the temperature above the set temperature is sensed by the temperature sensing unit; and a spray unit including a spray hole for ejecting the water resource transferred through the Bernoulli screw unit to the outside.

On the other hand, a plurality of through-holes passing through the water resource are formed in the water resource collection through-hole portion, and a filtering member for blocking the inflow of foreign substances is provided at the upper portion of the water resource collection through-hole portion The through-hole formed in the water resource collection through-hole portion has a groove having an open upper portion, and a hole having a relatively small width compared to the groove at the bottom of the groove so as to penetrate the upper portion of the upper portion.

In addition, a water resource collection extension unit made of a waterproof material is installed on both sides of the water resource collection through hole unit to be coupled to an upper portion of the water resource waterway unit, and a water resource collection extension unit made of a waterproof material is installed on an upper side surface of the coupling attachment unit to extend a collection range of a water resource,

The water resource inflow part comprises: a water resource collection through hole part having a plurality of through-holes for introducing water resources to the lower part; a filtering member provided on the upper part of the water resource collection through-hole part; and an opening and closing rod part provided at the lower part of the water resource collection through-hole part to which an elastic member opened by water pressure is attached when the water resource is introduced.

Here, the water resource collection through hole part is formed in a central part of the support made of a smooth concave shape formed in the water tank evaporation membrane part, and it is preferable to introduce the water resource collected from the upper part of the water resource collection through hole part to the lower part of the water storage tank located in the lower part.

In addition, an air suction pipe for introducing air for suppressing the decomposition of the water resources stored in the water storage tank is formed in the low water tank evaporation membrane part. An opening and closing bar part in which an elastic member is attached to one side inside the air suction pipe, a Bernoulli screw part having a twisted S-shaped screw is provided inside the air suction pipe, and a bubble generating part is formed on one end of the air suction pipe.

In addition, an air discharge pipe for discharging air for suppressing the decomposition of the water resources stored in the water storage tank is formed in the storage tank evaporation layer, and an elastic member is attached to one side inside the air discharge pipe, and a Bernoulli screw part having a twisted S-shaped screw is provided inside the air discharge pipe.

a water resource supply pipe for supplying the water resources stored in the water storage tank to the residential or industrial facility can be installed in the water tank evaporation membrane unit.

In addition, one end of the water resource collection unit protrudes from the ground, and the other end passes through the water resource collection through hole unit of the water resource collection unit through the ground to be connected to the water resource waterway unit Therefore, a medicine can be injected into the water resource stored in the water resource waterway unit through the drug input unit.

### Effect of the Present Invention

According to the present invention, the water resource utilization structure is installed in various types in which water resources such as rainwater or snow can permeate, thereby collecting and efficiently collecting water resources, transferring and storing the collected water resources, and providing the collected water resources to various environments requiring water resources. Accordingly, the waste resources can be prevented from being wasted, and the water resources are efficiently provided to various environments requiring water resources, thereby improving quality of life of the earth, improving the quality of life of the earth, improving the quality of life of the earth, improving the quality of life of the earth, and maintaining the sustainable green growth of the earth.

### BRIEF DESCRIPTION OF THE DRAWINGS

FIG. 1

The present invention relates to an installation concept of a water resource utilization structure according to the present invention,

FIG. 2 is a partial cross-sectional side view of a water resource utilization structure according to the present invention,

FIG. 3

The present invention relates to an installation concept of a water resource collection unit according to the present invention,

FIG. 4 is a block diagram of a water resource waterway part provided in a water resource collection part according to the present invention,

FIG. 5 is a structure of a drain pipe for fire suppression according to the present invention,

FIG. 6

The present invention relates to an installation concept of a water resource storage unit according to the present invention,

FIG. 7 is a block diagram of an air suction pipe according to the present invention.

FIG. 8 is a block diagram of an air discharge pipe according to the present invention.

FIG. 9 illustrates an installation concept of a water resource utilization structure according to another embodiment of the present invention.

### BEST FORM FOR THE PRACTICE OF THE INVENTION

Hereinafter, a preferred embodiment of the present invention will be described in detail with reference to the accompanying drawings.

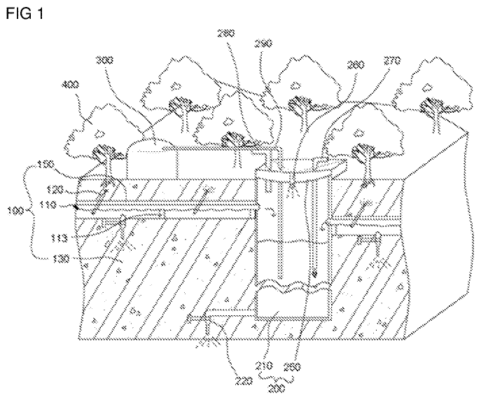

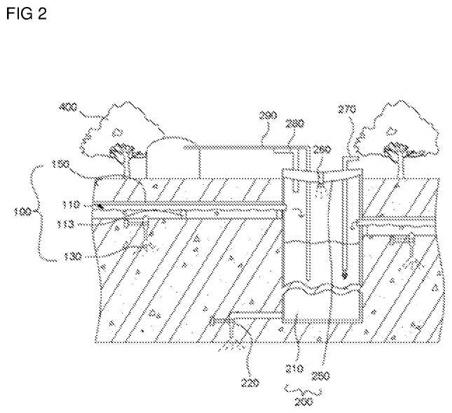

FIG. 1 is an installation concept of a water resource utilization structure according to an embodiment of the present invention, and FIG. 2 is a partial side cross-sectional view of a water resource utilization structure.

As shown in FIGS. 1 and 2, the water resource utilization structure according to the present invention is a structure for collecting and storing water resources permeated into the ground and distributing the water resources to a place requiring stored water resources, and comprises: a water resource collection unit (100) buried in the ground to collect water resources permeated into the ground; and a water resource storage unit (200) receiving and storing the water resources collected from the water resource collection unit (100).

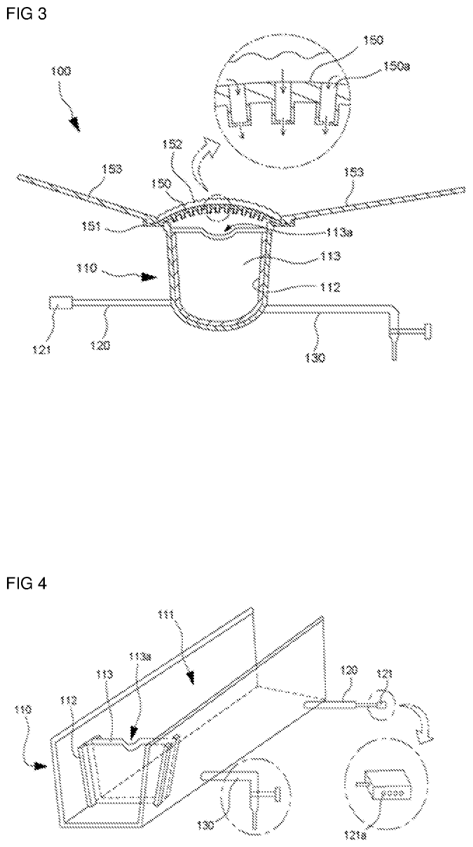

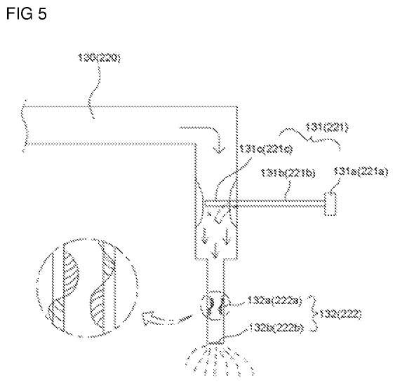

FIG. 3 is an installation concept of a water resource collection unit according to an embodiment of the present invention, and FIG. 4 shows an example of another form of a water resource collection unit provided in a water resource collection unit.

As shown in FIGS. 1 to 4, the water resource collection part (100) comprises: a water resource waterway part (110) for storing and transferring water resources through an inner water storage space; and a water resource collection through-hole part (150) coupled to the opened upper part of the water resource waterway part (110) to collect water resources permeated into the ground and to flow into a water resource waterway part (110) located at the lower part.

The water resource waterway part (110) is formed in a shape in which a side surface and a lower part are sealed to form a water storage space inside, and a water resource inflow opening part (111) of an open type is formed on the upper part to receive water resources from a water resource collection through hole part (150) located on the upper part. The water resource waterway part (110) can be formed in various shapes in which water resources such as semi-circular, trapezoidal, rectangular, etc. can be stored. According to an embodiment of the present invention, the water resource block unit (113) is detachably coupled to the detachable unit (112) by a water resource film formed inside the water resource waterway unit (110), but the water resource blocking unit (113) may be integrally formed in the water resource waterway unit (110). On the other hand, a water resource flow part (113a) in the form of a groove is formed on the upper part of the water resource block part (113) so that the water resource can be transferred to the side when the water resource stored in the water resource waterway part (110) reaches a certain level. The water resource block part (113) is installed in the water resource waterway part (110) at a predetermined interval. The water resource stored in the water resource waterway part (110) is transferred to the side through the water resource flow part (113a) of the water resource block part (113). That is, when the water level of the water resources stored in the water resource waterway part (110) is greater than or equal to the water resource flow part (113a) of the water resource block part (113), the water resource is transferred to one side through the upper part of the water resource flow part (113a) or the water resource blocking part (113), and finally flows into the water resource storage part (200).

a tree drain pipe (120) for supplying water resources stored in the lower part of the water resource waterway part (110) to a tree (400) planted in the forest; and a fire suppression drain pipe (130) for extinguishing the fire by spraying water resources when a fire such as a forest fire occurs.

The tree drain pipe (120) is connected to the lower part of the water resource waterway part (110) and is extended to the vicinity of the root of the tree (400) planted around the water resource waterway part (110) to supply water resources. A drip part (121) is buried in the ground to distribute and supply water resources to the root part of the tree (400). According to an embodiment of the present invention, a cap (121a) having a partial fine mesh is attached to a side surface or a lower part of the drip unit (121), thereby preventing clogging due to soil and supplying water to the root of the tree (400).
The drain pipe (130) for fire suppression is extended to be communicated fro the
lower part of the water resource waterway part (110) and has one end protruding
from the ground, and FIG. 5 shows a structure of a drain pipe for fire suppression.
As shown in FIGS. 1 to 5, the drain pipe (130) for fire suppression according to the
present invention comprises: a drain opening and closing unit (131) for opening and
closing a drain pipe (130) for fire suppression; and a spray unit (132) for
extinguishing a fire by ejecting water resources onto the ground when the drain pipe
(130) for fire suppression is opened through the drain opening/closing unit (131).

The drain opening and closing unit (131) includes: a temperature sensing unit (131a) which is displayed on the ground and senses the surrounding temperature; a bimetal unit (131b) in which the sensed heat is transferred when the temperature higher than the set temperature is sensed by the temperature sensing unit (131a); and a bimetal opening and closing unit (131c) which opens and closes the drain pipe (130) for fire suppression through heat transferred through the bimetal unit (131b). Accordingly, the water resource is not transferred by closing the drain pipe (130) for fire suppression through a bimetal opening/closing unit (131c) made by attaching two thin metal pieces having different thermal expansion rates. When heat is generated in the surroundings, heat generated is transferred to the bimetal opening/closing unit (131c) through the bimetal unit (131b) to open the drain pipe (130) for fire suppression by bending the bimetal opening/closing unit (131c) to one side according to the thermal expansion rate, thereby transferring the water resource in the direction of the spray unit (132). On the other hand, the temperature sensing part (131a), the bimetal part (131b), and the bimetal opening/closing part (131c) constituting the drain opening and closing part (131) are divided for convenience of explanation, and it can be composed of one bimetal automatic opening/closing device.

When the water resource is transferred by opening the bimetal opening/closing part (131c) in the spray part (132), a Bernoulli screw part (132a) for applying a rotational force to the transfer of the water resource through the twisted S-shaped screw is provided, and a spray hole (132b) for ejecting the water resource transferred through the Bernoulli screw part (132a) to the outside. Accordingly, the water resources transferred through the drain pipe (130) for fire suppression are rotated while passing through the Bernoulli screw part (132a), so that the water resources can be strongly sprayed through the injection hole (132b) to extinguish the forest fire.

On the other hand, a water resource collection through hole part (150) detachably coupled to the opened upper part of the water resource waterway part (110) is formed in a shape capable of withstanding earth pressure, and can be variously made, for example, in a gentle curved shape (semicircular shape), a straight shape, a triangular shape, a semi-diamond shape, and the like. A coupling attachment part (151) coupled to the upper part of the water resource waterway part (110) is formed on both sides of the water resource collection hole part (150), and the coupling attachment part (151) is detachably coupled to the upper part of the water resource waterway part (110) in a fitting manner to restrict movement. In addition, a plurality of through-holes (150a) are formed in the water resource collection through-hole unit (150), and water resources are collected in the ground to be introduced into a water resource waterway unit (110) located in the lower part. A filtering member (152) made of a non-woven fabric or the like is provided on the upper part of the water resource collection through-hole unit (150) to block the inflow of foreign substances included in the water resources. According to an embodiment of the present invention, the through-hole (150a) formed in the water resource collection through hole unit (150) has a groove with an open upper portion and a hole having a relatively smaller width than the groove at the bottom of the groove, thereby allowing the water resource passing through the filtering member (152) positioned on the upper portion to be smoothly introduced into the lower water resource waterway portion (110) through the through-hole (150a).

According to an embodiment of the present invention, a water resource collecting extension part (153) is installed on a side surface of a water resource collection hole part (150) to widen a water resource collection range. That is, the water resource collecting extension part (153) is installed on the upper side of the coupling attachment part (151) formed on both sides of the water resource collection through hole part (150). The water resource collecting extension part (153) collects water soaked in the ground and transfers the water to a water resource collection through hole part (150) located at the center of the downward direction. The water resource collection extension part (153) has a waterproof function such as a synthetic resin film, a metal plate, a plate, etc. and is made of any material if the water resource flow does not interfere with each other, and the size thereof can be appropriately changed according to the size of the installation area and the water resource waterway part (110).

The water resources collected through the water resource collecting part (100) are stored in a predetermined part through the water resource blocking part (113) of the water resource waterway part (110), and the water resources exceeding the water level of the water resource flow part (113a) of the water resource block part (113) are transferred to the side surface through the water resource flow part (113a) to flow into the water resource storage part (200).

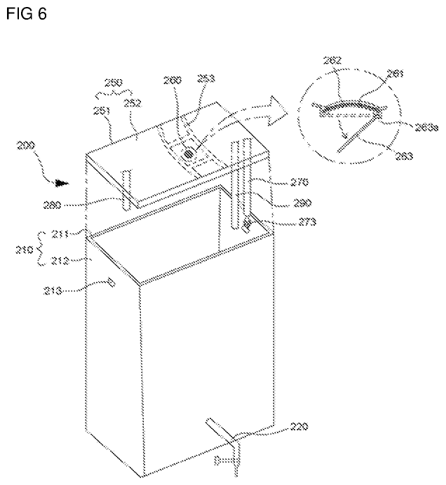

FIG. 6 shows an installation concept of a water resource storage part according to an embodiment of the present invention. The water resource storage part (200) comprises: a water storage tank (210) which collects and stores water resources transferred by being transferred through a water resource waterway part (110); and a water tank evaporation blocking part (250) which is combined with the opened upper part of the water tank (210) to enter a water resource flowing from the upper part into a water tank (210) located in the lower part and prevents evaporation of the water resources stored in the water tank (210).

The water storage tank (210) is a water storage tank storing and storing water resources. The water storage tank (210) has a waterway part connection part (213) in which one end of a water resource waterway part (110) is coupled and receives water resources from the water resource waterway part (110), and a fire suppression drain pipe (220) for extinguishing the fire by spraying water resources stored in the water tank (210) when a fire such as forest fire occurs. The drain pipe (220) for fire suppression comprises: a drain opening and closing unit (221) having a temperature sensing unit (221a), a bimetal unit (221b), and a bimetal opening and closing unit (221c); and a spray unit (222) having a Bernoulli screw unit (222a) and an injection hole (222b).The water tank (210) can be made of various materials having a waterproof function such as stainless steel (STS), SMC (SMC), concrete (CON), PE (PE), PPY (PPY), FRP (FRP), etc. which can be manufactured by coupling a waterproof member (212) to a lower frame (211) forming an integral or frame.

The water tank evaporation membrane part (250) is made of a material having a waterproof function like a water tank (210) to be manufactured by coupling a waterproof member (252) to an upper frame (251) forming an integral or a frame.

A support (253) forming a smooth concave shape is formed in the lower part of the water tank evaporation blocking part (250) to enter a water tank (210) located in the lower part, and a water resource inlet part (260) is formed at the center of the support (253). The water resource inflow part (260) comprises: a water resource collection through hole part (261) formed in a central part of a support (253) and having a plurality of through-holes for introducing water resources to the lower part; a filtering member (262) provided on the outside of the water resource collection through-hole part (261) to filter foreign substances contained in the water resources; and an opening and closing rod part (263) provided at the lower part of the water resource collection through-hole part (261) to be opened by water pressure when water resources are introduced. The water resource collection through-hole part (261) has a structure similar to that of the water resource collection through-hole part (150) of the water resource collection part (100), which is shown in FIG. 3, wherein the water resource collection through-hole part (261) has a gentle curve shape, and a plurality of through-holes formed in the water resource collection through-hole part (261) penetrate the upper and lower parts through a groove having an open upper part and a small hole formed on the bottom of the groove. In addition, an elastic member (263a) made of a material such as a spring, a spring, or an elastic rubber plate is coupled to the opening/closing rod part (263), so that the water resource stored in the water tank (210) is closed so that the water resource stored in the water tank (210) is not evaporated through the water resource collection through-hole part (261). When the water resource is introduced through the collection through-hole part (261), the water resource is opened to the lower part by the water pressure to introduce the water resource into the lower water tank (210).

On the other hand, an air suction pipe (270) for introducing air into the reservoir (210) and an air discharge pipe (280) for discharging the air of the water tank (210) to the outside are installed in the storage tank (210) in order to suppress the decomposition of the water resources stored in the water storage tank (210).

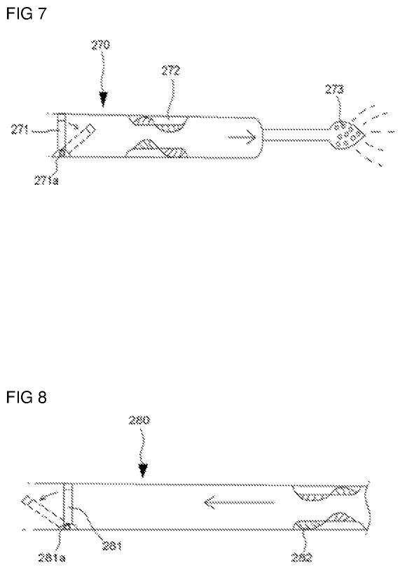

FIG. 7 shows a configuration of an air suction pipe according to an embodiment of the present invention. The air suction pipe 270 includes an opening/closing rod part 271 having an elastic member 271a attached to one side thereof, a Bernoulli screw part 272 having a twisted S-shaped screw therein, and a bubble generating part 273 formed at one end thereof. Therefore, when the air is sucked into the air suction pipe (270) from the outside, the opening and closing bar part (271) is opened by the sucked air, and the air is transferred along the air suction pipe (270). The air transferred along the air suction pipe (270) passes through the Bernoulli screw part (272) and flows into the water tank (210) through the bubble generating part (273).The air suction pipe (270) preferably has a length such that the bubble generator (273) can be located in the water resource stored in the water tank (210). When there is no air inflow to the air suction pipe (270), the opening and closing rod part (271) closes the air suction pipe (270) by the elasticity of the elastic member (271a) to prevent evaporation of the water resource. The air suction pipe (270) receives air by means of an air inflow fan (not shown) installed on the outside of the water tank evaporation membrane unit (250).

FIG. 8 is a block diagram of an air discharge pipe according to an embodiment of the present invention. The air discharge pipe 280 includes an opening/closing rod portion 281 having an elastic member 281a attached to one side thereof, and a Bernoulli screw portion 282 having a twisted S-shaped screw therein. One end of the air discharge pipe (280) is exposed to the air inside the water tank (210), and the other end is extended to protrude to the outside of the storage tank (250). The air inside the water tank (210) is discharged to the outside through the open opening and closing rod part (281), and the air discharge pipe (280) discharges air by means of an air discharge fan (not shown) installed on the outside of the water tank evaporation membrane part (250). In addition, when the air discharge pipe (280) does not discharge air, the air discharge pipe (280) closes the air discharge pipe (281) by the elasticity of the elastic member (281a) to prevent evaporation of water resources.

One end of the water resource supply pipe (290) is located in the water resource stored in the water tank (210), and the other end is connected to the residential and industrial facility (300) to be connected to the residential and industrial facility (300) to supply the water resources stored in the water tank (210) to the residential and industrial facility (300) through a pump (not shown) installed in the water resource supply pipe (290).

According to the present invention, the water resource utilization structure comprises: a water resource collection unit (100); a water resource collection unit (100); a water resource collection unit (100); and a water resource collection unit (150).

In addition, when the water stored in the water resource waterway unit (110) is higher than a predetermined level, the water resources stored through the water resource flow unit (113a) of the water resource block unit (113) are introduced into the water tank (210) of the water resource storage unit (200) to be stored.

the water resources stored in the water storage tank (210) of the water resource storage unit (200) are sprayed through a drain pipe (220) for fire suppression in the event of a fire to extinguish the fire, and if necessary, the water resources are supplied to the residential and industrial facility (300) through a water resource supply pipe (290).

In addition, the low water tank evaporation blocking part (250) coupled to the upper part of the water tank (210) of the water resource storage part (200) collects the water resources introduced from the upper part and flows into the water tank (210) located at the lower part through the water resource inlet part (260), and the air of the water tank (210) is fresh through the air suction pipe (270) and the air discharge pipe (280) to prevent the water resources from being wasted.

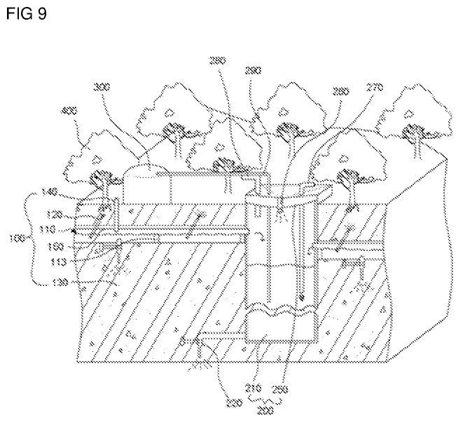

Meanwhile, the water resource utilization structure according to the present invention can be modified so that various devices can be added to widen a water resource utilization range. FIG. 9 is an installation concept of a water resource utilization structure according to another embodiment of the present invention, wherein a drug input unit (140) is installed in a water resource collection unit (100) to insert a medicine into a water resource waterway unit (110). That is, one end protrudes from the ground and the other end passes through the water resource collection through hole unit (150) of the water resource collection unit (100) to communicate with the water resource waterway unit (110), thereby promoting the growth of the tree (400) and maintaining the state of the water resource.

As such, the present invention is not limited to the above-described embodiment, and it is understood by those skilled in the art that various modifications and variations can be made therein without departing from the spirit and scope of the present invention as defined by a person skilled in the art to which the present invention belongs.

### FORM FOR THE PRACTICE OF THE INVENTION

According to the present invention, a sign is divided into a description of a code.

100 WATER RESOURCE COLLECTION UNIT 110 AND WATER RESOURCE WATERWAY UNIT

111 WATER RESOURCE INFLOW OPENING 112 AND WATER RESOURCE MEMBRANE ATTACHING/DETACHING UNIT

113 WATER RESOURCE MEMBRANE UNIT 113A: WATER RESOURCE FLOW UNIT

120 DRAIN PIPE 121 FOR TREE

121 A: CAP 130: A DRAIN PIPE FOR FIRE SUPPRESSION

131 DRAIN OPENING AND CLOSING PART 131A: TEMPERATURE SENSING PART

131 B: BIMETAL PART 131C: BIMETAL OPENING AND CLOSING PART

132 SPRAY PART 132A: BERNOULLI SCREW PART

132 INJECTION HOLE 140: DRUG INJECTION UNIT

150 THROUGH-HOLE OF WATER RESOURCE COLLECTION THROUGH-HOLE

151 COUPLING ATTACHMENT PART 152: A FILTERING MEMBER

153 WATER RESOURCE COLLECTION EXPANSION UNIT 200: WATER RESOURCE STORAGE UNIT

210 LOW WATER TANK 211: LOWER FRAME

212 WATERPROOF MEMBER 213: WATERWAY PART CONNECTION PART

220 DRAIN OPENING AND CLOSING UNIT FOR FIRE SUPPRESSION

221 A: TEMPERATURE SENSING PART 221 B: BIMETAL PART

221 C: BIMETAL OPENING/CLOSING PART 222: SPRAYING PART

222 A BERNOULLI SCREW PART 222B

250 LOWER WATER TANK EVAPORATION MEMBRANE PART 251: UPPER FRAME

252 WATERPROOF MEMBER 253: SUPPORT

260 WATER RESOURCE INLET 261: WATER RESOURCE COLLECTION THROUGH HOLE UNIT

262 FILTERING MEMBER 263: OPENING AND CLOSING ROD PART

263 ELASTIC MEMBER 270: AIR SUCTION PIPE

271 ELASTIC MEMBER FOR OPENING AND CLOSING ROD

272 BERNOULLI SCREW UNIT 273: BUBBLE GENERATION UNIT

280 AIR DISCHARGE PIPE 281: OPENING AND CLOSING ROD PART

281 A: ELASTIC MEMBER 282: BERNOULLI SCREW PART

290 WATER RESOURCE SUPPLY PIPE 300: RESIDENTIAL AND INDUSTRIAL FACILITY

400 TREE

The description of the code is an organic relation, and a water resource utilization structure is described.

### INDUSTRIAL APPLICABILITY

METHOD FOR PREVENTING CLOGGING OF EARTH

COMPOSITION FOR PREVENTING FOREST FIRE, PREVENTING FIRE, AND COMPOSITION FOR GROWTH ENVIRONMENT OF WOOD, TREE AND PLANT, AND THE LIKE, AND METHOD FOR MANUFACTURING THE SAME

COMPOSITION FOR RAINFALL FARMING OF EARTH, COMPOSITION FOR GROWING GROWTH ENVIRONMENT OF CULTIVATION PLANT, AND THE LIKE, AND METHOD FOR MANUFACTURING THE SAME

CONSTRUCTION METHOD FOR RAINWATER AND FINE DUST OF EARTH AND IRON AND FINE DUST INHIBITING ENVIRONMENT AND THE LIKE, AND METHOD FOR MANUFACTURING THE SAME

RAINFALL RESIDENTIAL AND INDUSTRIAL FACILITY OF EARTH AND INDUSTRIAL FACILITY, CULTIVATION FACILITY COMPOSITION (RAINFALL WATER RESOURCE AND AIR UTILIZATION), AND CONSTRUCTION METHOD THEREOF

METHOD FOR CONSTRUCTING OPTIMAL ENVIRONMENT IN CONSIDERATION OF TOPOGRAPHY CHARACTERISTICS AND THE LIKE (COMPOSITION OF TERRAIN IN CONSIDERATION OF TERRAIN CHARACTERISTICS AND THE LIKE), AND METHOD FOR MANUFACTURING SAME

WATER RESOURCE UTILIZATION STRUCTURE OF GREEN FIELD CAPABLE OF MAINTAINING EARTH

1. The water resource utilization structure comprises: a water resource waterway part (110) having an open upper part and storing and transferring a water resource through an inner water storage space; a water resource collection part (100) coupled to the opened upper part of the water resource waterway part (110) to collect water resources permeated into the ground,; and a water resource storage unit (200) coupled to an opened upper portion of the water tank (210) to enter a water resource introduced from the upper portion into a water tank (210) positioned at a lower portion and to prevent evaporation of the water resources stored in the water tank (210).

2. The water resource utilization structure according to claim 1, further comprising: a water resource block unit (113) for blocking and storing the flow of water resources collected in the water resource waterway unit (110); and a water resource flow unit (113a) in which a groove capable of transferring water resources is formed on an upper portion of the water resource block unit (113), and when the water level of the water resources stored in the water resource waterway unit (110) is greater than or equal to the water resource flow unit (113a) of the water resource block unit (113), water resources are transferred to one side to be introduced into the water storage tank (210).

3. The water resource utilization structure of claim 1, wherein a tree drain pipe (120) for supplying a stored water resource to a tree (400) is formed in the water resource waterway part (110), and a drip part (121) is provided at one end of the tree drain pipe (120) to distribute and supply water resources to the root part of the tree (400), wherein a cap (121a) having a partial fine net is attached to the drip part (121) to suppress clogging due to soil.

4. The water resource waterway part (110) or the water tank (210) comprises: a drain opening and closing part (131) (221) including a temperature sensing part (131a) (221a) and a bimetal opening and closing part (131c) (221c); and a bimetal opening and closing part (131c) (221c) opening and closing the fire suppression drain pipe (130) (220) through the heat transferred through the bimetal part (131b) (221b) when the heat of the set temperature or more is sensed by the temperature sensing part (131a, 221a)and spray holes (132, 222) including injection holes (132b, 222b) for ejecting water resources transferred through the Bernoulli screw units (132a, 222a) to the outside.

5. The water resource utilization structure of claim 1, wherein a plurality of through-holes (150a) through which water resources pass are formed in the water resource collection through-hole (150), and a filtering member (152) for blocking the inflow of foreign substances is provided at the upper part of the water resource collection through-hole (150). A hole (150a) formed in the water resource collection through hole (150) has a groove with an open top and a hole having a relatively smaller width than the groove at the bottom of the groove to penetrate the upper and lower parts.

6. The water resource utilization structure of claim 1, wherein a water resource collection extension part (153) is installed on both sides of the water resource collection through hole part (150) to be coupled to the upper part of the water resource waterway part (110). A water resource collecting extension part (153) of a waterproof material is installed on the upper side of the coupling attachment part (151) to expand the collection range of the water resources

7. The water resource utilization structure of claim 1, wherein the water resource inflow portion comprises: a water resource collection through-hole portion having a plurality of through-holes for introducing water resources into a lower portion of the water resource inflow portion; a filtering member provided on an upper portion of the water resource collection through-hole portion; and an opening/closing rod portion provided at a lower portion of the water resource collection through-hole portion to which an elastic member opened by water pressure is attached.

8. The water resource utilization structure of claim 7, wherein the water resource collection through-hole unit is formed in a central portion of a support (253) made of a smooth concave shape formed in the water tank evaporation membrane unit (250), and allows a water resource collected from the upper portion of the water resource collection through-hole unit (261) to be introduced into a lower water tank (210) positioned below the water resource collection through-hole unit (261).

9. The water resource utilization structure of claim 1, wherein the low water tank evaporation membrane part has an air suction pipe for introducing air for suppressing the decomposition of the water resources stored in the water storage tank, an opening/closing rod part having an elastic member attached to one side of the air suction pipe, a Bernoulli screw part having an S-shaped screw twisted therein, and a bubble generating part formed at one end of the air suction pipe.

10. The water resource utilization structure of claim 1, wherein an air discharge pipe (280) for discharging air is formed in the water tank evaporation membrane unit (250) to suppress the decomposition of the water resources stored in the water tank (210), and an elastic member (281a) is attached to one side inside the air discharge pipe (280). A Bernoulli screw unit (282) with a twisted S-shaped screw is provided inside the air discharge pipe (280).

11. The water resource utilization structure of claim 1, wherein a water resource supply pipe (290) is installed in the water tank evaporation membrane part (250) to supply the water resources stored in the water tank (210) to the residential or industrial facility.

12. The water resource utilization structure of claim 1, wherein one end of the water resource collection unit (100) has one end protruding from the ground and the other end passes through the water resource collection through-hole unit (150) of the water resource collection unit (100) through the ground to communicate with the water resource waterway unit (110), and a drug can be injected into the water resource stored in the water resource waterway unit (110) through the drug input unit (140).
